(19) United States
(12) Patent Application Publication
(10) Pub. No.: US 2013/0232549 A1
(43) Pub. Date: Sep. 5, 2013

(54) METHOD AND APPARATUS FOR SECURING NETWORK COMMUNICATIONS

(71) Applicant: Michael Ian Hawkes, Rudyard Staffordshire (GB)

(72) Inventor: Michael Ian Hawkes, Rudyard Staffordshire (GB)

(21) Appl. No.: 13/882,858

(22) PCT Filed: Nov. 2, 2011
(86) PCT No.: PCT/GB2011/052131

§ 371 Date: May 16, 2013

(30) Foreign Application Priority Data
Nov. 2, 2010 (GB) 1018461.2

(51) Int. Cl. H04L 29/06

(52) U.S. Cl. CPC H04L 63/08
USPC 726/3

(57) ABSTRACT

A method for securing communications in a communications network between a first network component (e.g. user's device) and a second network component (e.g. service apparatus). At the first network component a first data set represents user-perceptible content which is reproduced for perception and selection by a user of the first network component. The method includes forming a network communications link between the first network component and the second network component subject to conditions requiring at least that a user input is received at the first network component indicating selection of the reproduced user-perceptible content by the user. The first data set is then replaced at the first network component with replacement data to represent the user-perceptible content for perception and selection by a user of the first network component in subsequently so forming a said communications link.

The present invention relates to methods and apparatus for securing network communications. In particular, though not exclusively, the invention relates to communications using a computer network or internet.

Presently, secure user access to the resources of a communications network, such as the Internet, generally rely on the provision to and/or by the user of a combination of three items:

(1) A resource locator, typically in the form of an internet web-address or internet protocol number sequence, to identify and locate the network resource;
(2) A pre-registered user name with which a user may be identified; and,
(3) A pass-code previously configured and associated with the user name to permit user authentication and maintain security.

This combination of information allows a computer system to locate the network resource (or web-site) and validate that a specific user has access to that resource.

Many network resources employ this type of access mechanism with the result that many people use the same user names and pass-codes across multiple network resources (e.g. multiple web-sites). Consequently, many Internet hosting facilities have to support databases containing numerous copies of largely identical authentication datasets, and much of the processing resource (and electrical power) consumed by internet-facing systems merely serve to protect the security of online resources. Compromising one hosting facility may effectively render compromised all others hosting/employing the same authentication data.

Furthermore, to input resource locators, user names and pass-codes a user predominantly types in alphanumeric data via a keyboard of other input device. Unauthorised third party software (e.g. “spyware”) monitoring a user's computer may monitor or log key strokes and draw a correlation between the network resources (e.g. web-sites) which are accessed and the sequence of keystrokes which result in that access. Such a breach of privacy is undesirable, highly so when secure network access is essential.

Generally speaking, individual users are prone to use one pass-code, unchanged, for a given network resource repeatedly and for a long period of time—it is inconvenient for a user to change a pass-code after each use. This is not least because the user must be confident that any new pass-code they employ will be memorable to them and, thus, remembered when needed in future. This is increasingly unlikely the more replacement pass-codes are used. Consequently, network users are prone to re-use alphanumeric pass-codes and user names. Thus, the security of user names and pass-codes may be more easily compromised by third party monitoring software (e.g. spyware) due to the current practical expediency of users re-using alphanumeric pass-codes and user names in order to access network resources.

The invention desirably may provide means and methods which may be used to address these deficiencies in the prior art.

At its most general the invention proposed is the use of data representing perceptible, recognisable content (e.g. imagery and/or sounds) for perception (e.g. by presentation) by a user and selection by the user as a means or prerequisite for securely establishing a communications link in a network. Recognisably the same user-perceptible content may be used multiple times for this purpose wherein the digital data subsequently used to representing that content may be made different (e.g. digitally different) to the data used to represent it when previously selected. This means that the digital data used on one occasion to represent the user-perceptible content selected to gain secure network access, need not be the same as the digital data used on a subsequent occasion to represent that user-perceptible content for the same purpose. However, the user-perceptible content represented by the data may remain substantially and recognisably (i.e. user-perceptibly) the same.

As a consequence, a user need not memorise or use an alphanumeric pass-code, or enter a sequence of key-strokes (which may be logged by spyware) when inputting data required for obtaining network access. Selection of the user-perceptible content by a user may cause transmission from the apparatus of the user of pass-code data to apparatus of a network resource provider via the network in question, and that pass-code data may be derived or derivable uniquely from the digital data representing the selected user-perceptible content. Consequently, the pass-code data derived from a first data set representing a given user-perceptible content on one occasion, may be different to the pass-code data derived from a second, different, data set used subsequently to represent perceptibly the same user-perceptible content on a subsequent occasion. This means that while a user may be able to recognise the user-perceptible content (e.g. imagery, sounds) presented on both occasions as being the same content (e.g. same image content, same audio content)—namely, their pass-code content—spyware may not be able to recognise the data representing the same user-perceptible content on both occasions.

The invention exploits the fact that humans are able to recognise images or sounds having a content associated with personally familiar subjects or themes. For example, a user is likely to be able to recognise an image of him/herself, or of a friend or family member or the like, even if that image content is represented on different occasions by data sufficiently different as to produce differences between the images (e.g. contrast, brightness, pixel resolution etc) presented on those occasions. A quite significant degree of data difference may be present without any perceptible difference to the images as perceived by the user. Furthermore, data differences may be so extreme as to impose relative, visible image distortions yet, if applied to familiar images, a user may still readily and easily recognise the different images as conveying the same content (e.g. a picture of the user at a specific time, location event known well to the user—e.g. “my graduation photograph”). The same principle applies to other types of content (e.g. audio content, video etc.).

For example, the invention may provide a method and/or apparatus requiring the provision by a first network nodal apparatus of information to a second network nodal apparatus (or for the second nodal apparatus; e.g. to network communications apparatus, such as a server or the like, in communication with the second nodal apparatus) as a prerequisite to allow communications therebetween (e.g. a means of authenticating a user). The required information may be contained in, or may be derivable from, the data used by the first network nodal apparatus to represent the user-perceptible content to be presented by it to a user of the first nodal network apparatus for selection, or rendered selectable by a user of the first network nodal apparatus. Selection of the data may thus be done by selection of the reproduced content (e.g. imagery, audio) recognised by the user. In this way, an unauthorised third party monitoring software, “spyware” or the like, may have much difficulty in correlating repeated selections/transmissions of what appear to be different digital data sets (representing the same user-selected content) with the formation specific communications link which results of the user's selection. That is to say, a causal relationship is much more difficult for spyware to discern. Generally speaking, spyware cannot perceive the user-perceptible content in the way that a human user can and so cannot build an association between repeated selection of the same content with the network link that selection of that content enables (e.g. a link to a users private internet banking website). This provides an alternative to entering a password, or the like, by alphanumeric keystrokes which may be easily monitored by spyware.

The digital data in question may be image data or audio data, for example, or a combination of both in the form of audio/visual (AV) data such as video or the like.

Where the user-perceptible content is an image (moving or still) it may be reproduced for presentation to a user in the form of, for example, an image tile, icon or sub-window within an overall user interface. This interface is preferably arranged to render the perceptible content selectable via an input made by a user of the user-interface by any suitable means such as would readily apparent to the skilled person. Where the user-perceptible content is audio data, it's reproduction may be commenced in response to a “play” command from a user of the user-interface and its subsequent selection achieved by a any suitable user-input selection command implemented according to any suitable input command means such as would be readily apparent to the skilled person. This enables the benefits of the invention to be enjoyed by the visually impaired. Network access may be access to a mobile phone network via a mobile phone handset or the like.

Multiple separate items of user-perceptible content may be reproduced simultaneously for perception by a user. For example, only one, some but not all of the reproduced content may be adapted to initiate or participate in secure network communications upon its selection by the interface user. In this way, a plurality of different items of user-perceptible content may be presented to a user in which only one or some of the those items are recognised by the user as being associated with the provision of secure network communications. Selection of one or some of those items of user-perceptible content, optionally depending upon a specified order of selection, may then enable secure network communications to commence.

For example, the user interface may be arranged to present simultaneously to a user a plurality of separate items of user-perceptible content (e.g. moving or still imagery and/or audio) in the form of an ordered array of items e.g. arranged in the manner of a keypad. The user may then select the appropriate items from the keypad as required to initiate or progress the process of forming the aforesaid network communications. The invention may provide that selections of other than those items of user-perceptible content required for progressing or initiating the aforesaid secure network communications link (e.g. due to an input error by the user), may initiate a network communications link to a different network nodal apparatus or service provider. The other network communications link may be to a non-secure link and may be a link to a network resource selected or preselected by the network nodal apparatus of the user. This provides a means of disguising the fact that a certain selection or sequence of selections of items of user-perceptible content by the user, is associated with the formation of a communications link to a specific network resource. This might otherwise be derivable if it were observed (e.g. by spyware) that certain selections of user-perceptible content do result in the formation of network communications links while others do not.

The data representing previously selected items of user-perceptible content may be replaced with different data representing the same user-perceptible content for future use as described above. The different data may be different in the sense of containing some of all of previously-used data, but arranged differently, or different amounts/parts of the data previously used, or include new data not contained in previously used data. Consequently, subsequent selection of the same item or items of user-perceptible content may employ different digital data. A third party monitoring or recording selections of these items of content would, therefore, fail to identify repeated selection of certain data (associated with the selection of recognised user-perceptible content by the user) and therefore would fail to associate the use/selection of that data with the consequences of its selection—namely, formation of a specific network communications link.

It is to be understood that the term “content” as used in the expression “user-perceptible content” is intended to include references to the perceivable information or impression conveyed to a recipient of the information represented by data conveying the content. For example, user user-perceptible content conveyed by image/audio/video data may be the image/audio/video communication or impression represented by the data for perception by a user. The term “user-perceptible” includes references to visual and/or aural/auditory perception by a user using the senses of sight and/or hearing. Other senses, such as the sense of touch, may be employed.

Vibrational content may be employed, for example, whereby a user device for touching or holding by a user (e.g. phone handset, mouse etc.) vibrates in a particular way when a user selects one of a number of images presented in an array each associated with a different mode of vibration. Alternatively, no images need be presented but different vibration modes may be executed by the user device one after the other in a sequence. A user may enter a selection signal (e.g. a voice command) when they feel the user device vibrate in a specific way, and ignore the others. The data conveying the vibration mode may be derived from a master data set so as to be digitally different after each use, but perceptibly no different to the user. This may be of benefit to visually impaired users. Vibrational bursts having a duration, and/or a pattern, and/or a pitch (i.e. speed of vibration) which are variable to produce recognisably different vibrational content may be used to represent different perceptible content. Burst durations may vary between about one second and about four seconds. Patterns of successive burst durations and/or pitches could be selected as desired in the manner of Morse Code or the like, to the user's requirements. Variations of several Hz in burst repetition rate, and/or variations of several microseconds in vibrational cycle period (i.e. frequency) are suitable to achieve clearly perceptible variety.

In a first of its aspects, the invention may provide a method for securing communications in a communications network between a first network component and a second network component including: providing at the first network component a first data set representing user-perceptible (e.g. audio and/or image) content, and reproducing the user-perceptible content using the first data set for perception and selection by a user of the first network component; and, forming a network communications link between the first network component and the second network component subject to conditions requiring at least that a user input is received at the first network component indicating selection of the reproduced user-perceptible content by the user; and subsequently, issuing to the first network component a second data set from network communications apparatus including at least the second network component which differs from the first data set but which represents the same said user-perceptible content; and, replacing the first data set with the second data set at the first network component to represent the user-perceptible content for perception and selection by a user of the first network component in subsequently so forming such a communications link.

In this way, formation of a network communications link is rendered dependent upon selection of reproduced user-perceptible content using data which is immediately replaced with different digital data, to represent the same user-perceptible content, thereby enabling the same user-perceptible content to be used again to make such a communications link subsequently without using the same data. Third parties are thereby prevented from associating the use of data representing a selected item of user-perceptible content with the formation of the network communications link resulting from that selection.

The network communications apparatus may comprise network components including substantially only the second network component such that the second network component is arranged to perform the functions of the network communications apparatus described herein. Alternatively, the network communications apparatus may comprise not only the second network component, but also a third network component such as a server which is arranged to perform some of the functions of the network communications apparatus described herein, while the second network component is arranged to perform other of those functions.

For example, the first network component may be arranged to communicate with the third network component (e.g. server) rather than with the second component when requesting access to the second network component. The third network component may be arranged to receive the request signals from the first network component and to authenticate the first network component using those signals. The third network component may be arranged to communicate a result of authentication (e.g. a positive result) to the second network component. The second network component may be responsive to the authentication report signal from the third network component by forming, or permitting the formation of, the communications link with the first network component. This communications link may be made directly with the first network component (e.g. not via the third network component) or may be made via the third network component (e.g. server linking the first and second network components in communication). The data sets employed by the first network component representing the user-perceptible content, may be generated by the third network component and communicated to the first network component for use thereby. Master data sets representing user-perceptible content, from which are derived the data sets used by the first network component, may be stored at the third network component.

In this way, the third network component may act as an intermediate network component for the storage of data sets, the replacement of used data sets and the authentication of communication request signals using those data sets and information derived from them. Alternatively, any, some or all of these functions may be performed by the second network component.

The forming of the communications link may include issuing a request signal from the first network component to the network communications apparatus (e.g. the second network component) requesting formation of the communications link wherein the request signal comprises data identifiable by the second network component as having been uniquely derived from the first data set; and, authenticating at the network communications apparatus (e.g. the second network component) the user of the first network component using the request signal, and subsequently issuing the second data set.

Consequently, selection of an appropriate item of user-perceptible content, by the user of the first network component, may initiate transmission to the network communications apparatus (e.g. the second network component) of data to which conditions are applied before a communications link is permitted by or with the second network component. The data in or of the request signal may comprise a key or code or other data item or items with which the network communications apparatus (e.g. the second network component) is arranged to assess the authenticity or identity of the user of the first network mode. The method may include generating the request signal comprising a numerical value derived from the first data set by applying thereto a numerical algorithm applicable by the network communications apparatus (e.g. the second network component) to identify the numerical value as having been derived from the first data set. The method may include generating the request signal comprising the first data set. The request signal may be generated at/by the first network component for receipt and use by the network communications apparatus (e.g. the second network component). Examples are including in the request signal the first data set, or a specified part of it, or a data item (e.g. numerical value) derived using the first data item according to an algorithm known to the second data item, such as a hash value derived according to a hash function applied by the first network component. Most preferably the network communications apparatus (e.g. the second network component) also contains the first data item and is arranged to be able to verify the authenticity of the request signal by comparison. This may be either direct comparison of the first data set contained in the request signal against the first data set held by the second network component, or comparison of the numerical value (e.g. hash value) contained in the request signal against a hash value derived by the network communications apparatus (e.g. the second network component) by applying the hash algorithm to the first data set held by it. When the network communications apparatus comprises a third nodal network component, such as a server, that third component may perform the above comparison and communicate authentication results to the second component.

The forming of the communications link may include generating at the first network component a user interface via which access to the second network component is obtainable by forming the communications link. The issuing to the first network component of the second data set from the network communications apparatus (e.g. the second network component) is preferably subject to the condition that the access is obtained using the user interface. In this way, a level of security may be provided by requiring that the user interface has been employed in the process of forming the secure communications link between the first and second network components. Access to, or the opening/initiation of, the user interface at the first network component may desirably be achieved by selecting a said first data set representing user-perceptible (e.g. audio and/or image) content reproduced at the first network component for perception and selection by a user for that purpose. That is to say, selection of an item of such content may be a required initial step to begin/permit subsequent steps required in forming the secure link with the second network component. Such subsequent steps may include further selection(s) of other such user-perceptible content conveyed by an additional such first data set(s) also required as conditions of formation of the communications link. For example, an item of user-perceptible content may be selectable on a user's screen as a means to open/initiate presentation of another item or items of user-perceptible content who's selection (optionally, in a sequence of selection matching a specified sequence) is a requirement of forming the communications link.

The following relates to the method in any aspect above.

The method may include generating the first data set and the second data set using a common master data set which represents the user-perceptible content. The master data set may be provided to the second network component by the user fir storage there. For example, an image/video clip or audio clip well known personally to the user maybe provided as the master. Subsequently, the aforesaid first data set and its subsequent replacements, may be each derived from the master data set in a way which produces a respective first data set which differs from the previous digitally.

The method may include generating the second data set at the second network component for the first network component. Thus, generation of the first data sets and their association with the master data set may be kept physically separate from the first network component where the first data sets are to be used. The second network component may transmit a first data set to the first network component. It may transmit each subsequent, replacement second data set to the first network component after each successive formation of the communications link therewith.

The method may include generating the first data set and the second data set to comprise less data than is employed by the master data set to represent the user-perceptible content. This provides a means of making first and second data sets different—i.e. by using different sub-parts of the master image, respectively. It also means that data transmission load is reduced. A large master image data set may be used without jeopardising transmission speeds between the first and second network components when transmitting the data sets. The method may include generating the first data set and the second data set comprising data which is sub-sampled from the master data set. The master data set may be sub-sampled in Fourier space such that the first and second data sets have a different set of Fourier components which may be smaller in number and/or different in value to those of the master data set. Data decimation may be employed.

The master data set may represent an image. The sub-sampling may be to sample only a selected number of image pixel rows and/or image pixel columns, or image pixels, either according to a regular sampling pattern or a random one. The data representing image qualities such as colour balance, contrast, brightness, sharpness etc may be changes when generating a first or second data set from the master data set.

The method may include generating the first data set and the second data set such that the image content reproduced therefrom is relatively shrunken as compared to the image content represented by the master data set if so reproduced. Image re-scaling or down-sampling may be employed. Preferably, the master image is entirely free of all meta data (e.g. data conveying other than image/audio signals; examples of meta data are such as the date an image was captured, the camera used, the dimensions of the image etc.) or the facility to hold meta data. This removes the possibility of unauthorised software (e.g. spyware, or data able to identify the master image) residing with the master image data within data regions of an image product often provided/generated by digital camera software for holding meta data associated with image data.

The method may include providing at the first network component a plurality of said first data sets which represent a respective user-perceptible content; and, reproducing the user-perceptible content of the plurality of first data sets simultaneously for perception and selection by the user of the first network component. Thus, multiple selectable items of user-perceptible content may be presented together for selection by a user. An array of such separate items of content may be presented in the form of a matrix, row, line or other structured arrangement of items collectively forming a group arrangement on the screen of the user's interface. One or more of the items of content may be selected via a selection means such as would be readily apparent to the skilled person—for example, each selectable item of content may be “active” and selectable by placing a cursor thereover and pressing an enter key or mouse key of a user's PC, or otherwise selecting using a touch screen such as is to be found on an iPhone® or the like. Items of image content may be presented each as a small image tile/window of sufficient size to enable the user to visually recognise the content consistently. The suitable image tile/window size may preferably be initially determined by a process of calibration (e.g. trial and error testing) with the user to enable the user to find the most preferred and suitable tile/window dimensions.

The forming of the network communications link is then preferably subject to conditions requiring at least that the user input is received indicating the selection of more than one of the reproduced user-perceptible content by the user. Thus, selection of a required one or more of the items of user-perceptible content (i.e. those recognised as such by the user) may be necessary before the link can be formed. Several may be required to be selected either in any order or in a predefined selection order. The conditions may include a requirement that the order of selection of said more than one reproduced user-perceptible contents matches a predetermined order.

The method may include providing a plurality of distinct said master data sets and generating the first and/or second data set from a master data set selected from amongst the plurality of master data sets. Thus, more than one master data set may be employed if the user wishes to be presented with user-perceptible content representing any one or more of the master content items (e.g. several master images and/or video and/or audio items). More generally, the method may include issuing to the first network component from the network communications apparatus (e.g. second network component) a third (optionally, and fourth, fifth . . . etc.) data set in association with the second data set which represents a different user-perceptible content; and, reproducing the user-perceptible contents of both the second data set and the third data (optionally, and fourth, fifth . . . etc.) set simultaneously for perception and selection by a user of the first network component. The selection at the first network component of each of the user-perceptible items of content represented by the second and third (or more) data sets may be a requirement of access to the second network component. The selection may be at different levels of the user interface (e.g. firstly to initiate the interface using the second data set, then to enter a pass-code within the opened interface using one or more of the third, fourth . . . data sets).

The above method may be implemented by apparatus arranged to perform the steps and functions of the method. Such apparatus so arranged is encompassed within the invention.

For example, in a second of its aspect, the invention may provide apparatus for securing communications in a communications network between a first network component and a second network component including: a first network component comprising a first data set representing user-perceptible (e.g. audio and/or image) content, and arranged to reproduce the user-perceptible content using the first data set for perception and selection by a user of the first network component; and network communications apparatus comprising at least a second network component arranged to form a network communications link with the first network component subject to conditions requiring at least that a user input is received at the first network component indicating selection of the reproduced user-perceptible content by the user; and subsequently to issue to the first network component a second data set which differs from the first data set but which represents the same said user-perceptible content; wherein, the first network component is arranged to replace the first data set with the second data set to represent the user-perceptible content for perception and selection by a user of the first network component in subsequently so forming said communications link.

The first network component may be arranged to issue a request signal to the network communications apparatus (e.g. the second network component) requesting formation of the communications link wherein the request signal comprises data identifiable by the network communications apparatus (e.g. the second network component) as having been uniquely derived from the first data set. The network communications apparatus (e.g. the second network component) may be arranged to authenticate the user of the first network component using the request signal, and subsequently to issue the second data set.

The first network component may be arranged to generate the request signal comprising a numerical value derived from the first data set by applying thereto a numerical algorithm applicable by the network communications apparatus (e.g. the second network component) to identify the numerical value as having been derived from the first data set.

The first network component may be arranged to generate the request signal comprising the first data set.

The first network component may be arranged to generate a user interface via which access to the second network component is obtainable by forming the communications link. The network communications apparatus (e.g. the second network component) may be arranged to issue the second data set to the first network component subject to the condition that the access is obtained using the user interface.

The apparatus is preferably arranged to generate the first data set and the second data set using a common master data set which represents the user-perceptible content.

The network communications apparatus (e.g. the second network component) is preferably arranged to generate the second data set for the first network component.

The apparatus may be arranged to generate the first data set and the second data set to comprise less data than is employed by the master data set to represent the user-perceptible content.

The apparatus may be arranged to generate the first data set and the second data set comprising data which is sub-sampled from the master data set.

The master data set may represent an image. The apparatus may be arranged to generate the first data set and the second data set such that the image content reproduced therefrom is relatively shrunken as compared to the image content represented by the master data set if so reproduced.

The apparatus may be arranged so that the first network component contains a plurality of said first data sets which represent a respective user-perceptible content. The first network component may be arranged to reproduce the user-perceptible content of the plurality of first data sets simultaneously for perception and selection by the user of the first network component. The network communications apparatus (e.g. the second network component) may be arranged to form the network communications link subject to conditions requiring at least that the user input is received indicating the selection of more than one of the reproduced user-perceptible content by the user.

The conditions may include a requirement that the order of selection of said more than one reproduced user-perceptible contents is a predetermined.

The apparatus may comprise a plurality of distinct said master data sets and arranged to generate the first and/or second data set from a master data set selected from amongst the plurality of master data sets.

The network communications apparatus (e.g. the second network component) may be arranged to issue to the first network component a third data set in association with the second data set which represents a different user-perceptible content. The first network component may be arranged to reproduce the user-perceptible contents of both the second data set and the third data set simultaneously for perception and selection by a user of the first network component.

In a third of its aspects, the invention may provide apparatus for securing communications in a communications network between a first network component and a second network component including: the second network component comprising a master data set representing user-perceptible content, and arranged to generate a first data set derived from and differing from said master data set representing the user-perceptible content for reproduction, perception and selection by a user of the first network component; wherein, the second network component is arranged to transmit said first data set to said first network component and subsequently to form a network communications link with the first network component subject to conditions requiring at least that data is received thereby from the first network component indicating selection of the reproduced user-perceptible content by the user; and subsequently to issue to the first network component a second data set derived from the master data set which differs from the first data set but which represents the same said user-perceptible content for subsequent perception and selection by a user of the first network component.

In a fourth of its aspects, the invention may provide a method for securing communications in a communications network between a first network component and a second network component including: providing at the second network component a master data set representing user-perceptible content, and generating therefrom a first data set differing from said master data set representing the user-perceptible content for reproduction, perception and selection by a user of the first network component; and transmitting said first data set to said first network component and subsequently forming a network communications link with the first network component subject to conditions requiring at least that data is received by the second network component from the first network component indicating selection of the reproduced user-perceptible content by the user; and subsequently, issuing to the first network component a second data set derived from the master data set which differs from the first data set but which represents the same said user-perceptible content for perception and selection by a user of the first network component.

In a fifth of its aspects, the invention may provide a computer program comprising computer-executable instructions executable by a computer to implement the method described above. The invention may provide a computer program product comprising a computer-readable data storage medium comprising computer-executable instructions executable by a computer to implement the method described above.

In a sixth of its aspects, the invention may comprise a computer containing the computer program, or programmed to implement the method described above.

In a seventh of its aspects, the invention may provide a communications network comprising the apparatus described above.

In a further aspect, the invention may provide a method a method including providing a data set representing user-perceptible content reproducible for perception by a user, modifying the data set representing the user-perceptible content to provide a modified data set, associating the modified data set with a command (e.g. to be issued from one network apparatus to another), reproducing the user-perceptible content according to the modified data set for perception by the user for selection thereby, issuing the command if the reproduced user-perceptible content is selected by the user, subsequently modifying the data set representing the user-perceptible content to provide a subsequently modified data set for reproducing said content for perception and selection by the user, wherein the subsequently modified data asset differs from the modified data set, and associating the subsequently modified data set with the command.

The apparatus described above is preferably arranged to implement a method described above.

Examples of preferred embodiments of the invention will now be described for illustrative purposes, with reference to the accompanying drawings of which:

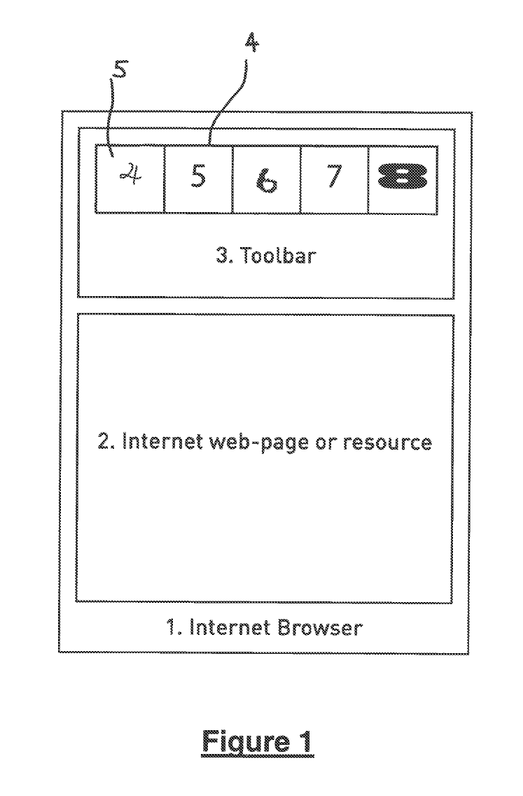

FIG. 1 illustrates schematically the graphical user interface of a software application implemented on a node (e.g. computer) of a network requiring access to another node (e.g. computer) of the network;

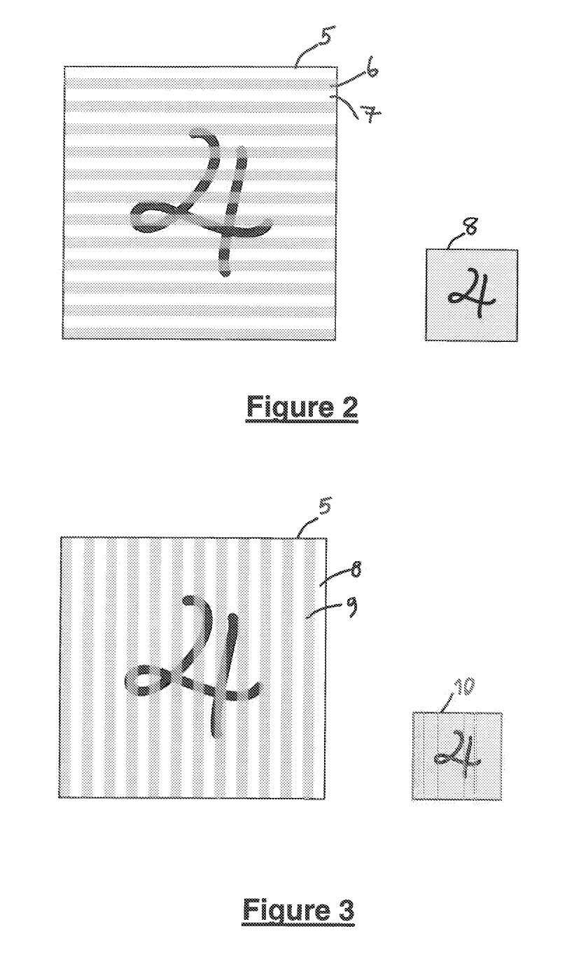

FIG. 2 illustrates schematically a first method for reduction of the size of a master image to produce an image for use in the graphical user interface of FIG. 1;

FIG. 3 illustrates schematically a second method for reduction of the size of a master image to produce an image for use in the graphical user interface of FIG. 1;

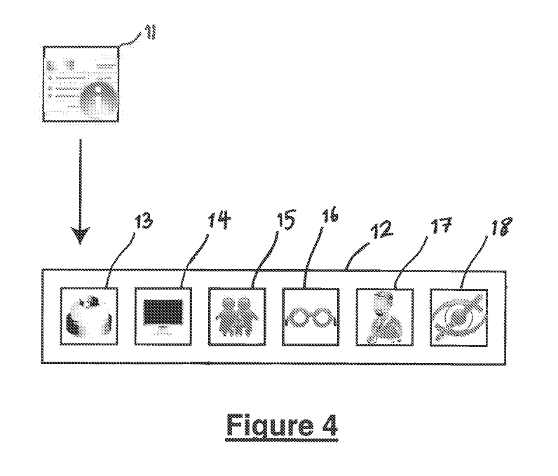

FIG. 4 schematically illustrates a first component of a graphical user interface of a software application implemented on a node (e.g. computer) of a network requiring access to another node (e.g. computer) of the network and comprising an array of user-selectable images and responsive to selection of an image to initiate the process of forming a communications link with a respective network service associated with the image;

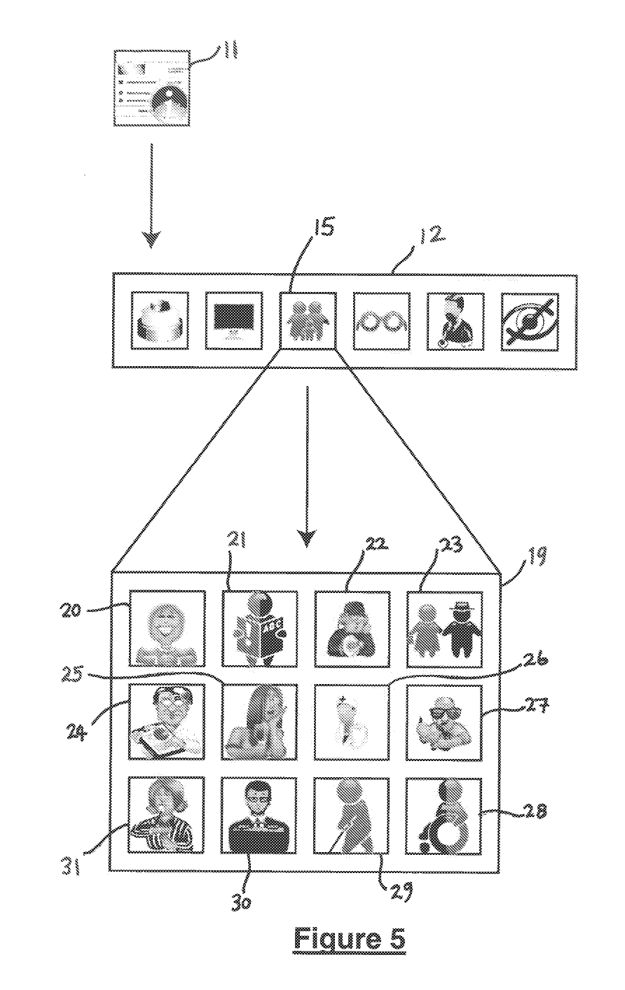

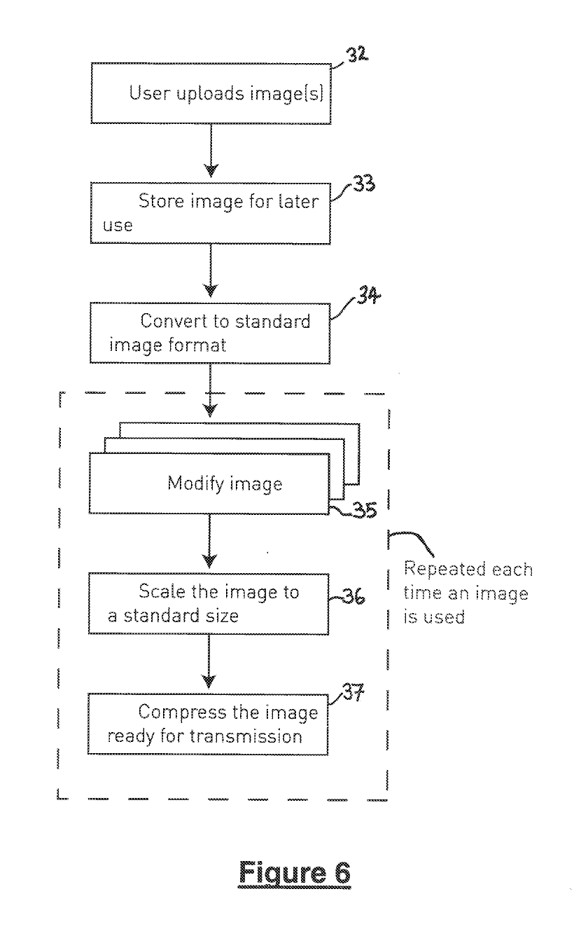

FIG. 5 schematically illustrates a second component of the user interface of FIG. 4 accessible in response to user selection of an image within the first component of the graphical user interface, and via which a pass-code is enterable by appropriate selection of one or more of the plurality of images presented thereby;

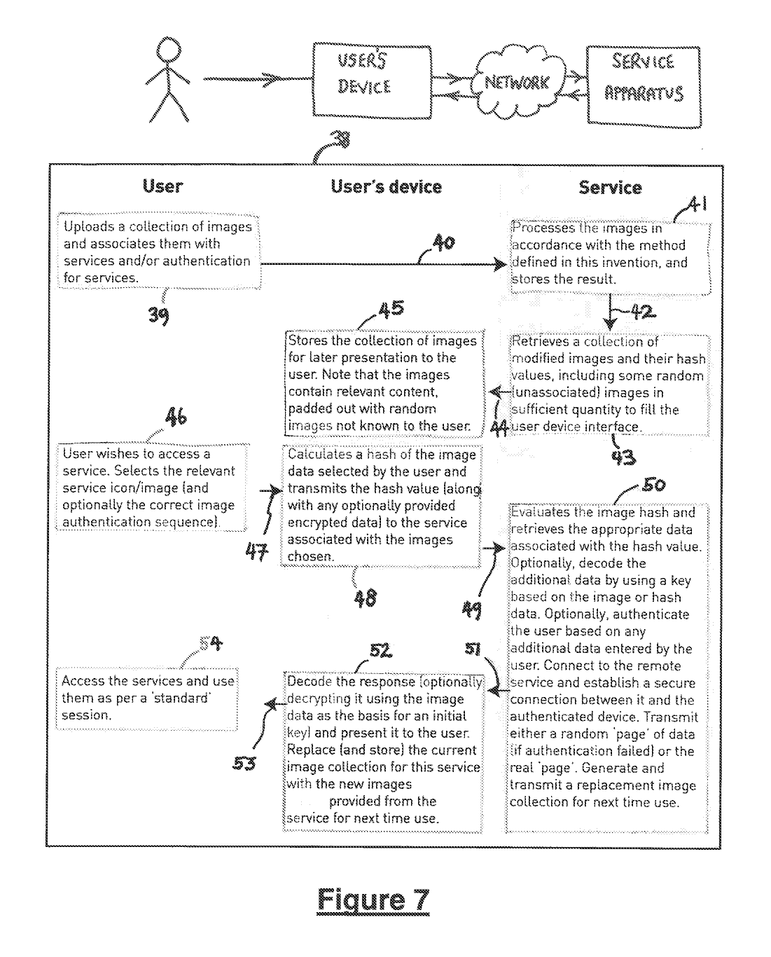

FIG. 6 schematically illustrates data input/output and image processing steps implemented by software on a node (e.g. computer) of a network according to preferred embodiments of the invention;

FIG. 7 graphically implements a flow chart showing a sequence of steps which may be performed in implementing preferred embodiments of the invention.

In the drawings like elements are assigned like reference symbols.

Preferred embodiments of the invention embody or implement a method or apparatus to arranged to locate network resources more easily, and/or preferably to access network resources within a more secure and much simpler context than currently available and/or to preferably utilise user-perceptible information (including, among other things, images, video, audio, or the like) as part of an encryption mechanism to secure communications. The invention may provide a network access mechanism that helps people communicate securely while removing unnecessary hardware, databases, digital certificates and management overheads.

While embodiments of the invention are referred to below in terms of internet communications, the invention may also apply to other communication systems.

FIG. 1 schematically illustrates a software application such as an Internet Browser (1), executed on a first network nodal apparatus (e.g. a computer) requiring access to a second network apparatus (e.g. a server). An application interface is provided via the Internet Browser in the form of an Internet web-page or resource (2) possessing a navigation mechanism to provide access to network resources.

A toolbar (3) interface is provided by the Internet Browser comprising a collection of five different and independent images (4) presented for perception and selection by a user. Selection of a given image may be achieved by placing an on-screen cursor (not shown) over the image in question within the toolbar (3) followed by entering a key stroke such as a mouse-click. Alternatively, if the Internet Browser is executed via a touch screen input device, selection may be by directly touching a part of the screen of a display device containing the selected image. Other mechanisms of selection may be employed such as would be readily apparent to the skilled person.

Each image is associated, within the Internet Browser application, with a predetermined command executable by the Internet Browser application. That is to say, the selection, by a user, of a given image (e.g. the image (5) of the number four “4”) of the collection of images, or the selection of a plurality of the images in an appropriate sequence, results in the computer upon which the Internet Browser is in operation responding by executing a pre-specified command or operation which is either:
(A) to issue a request, via the Internet, to a pre-specified web-page or resource to form a communications link with the apparatus executing the Internet Browser application; or,
(B) to initiate a user interface via designed to implement additional security measures which, if successfully completed, enables the issuance of the request (A) to be executed.

Each of the images of the collection of images (4) employs a respective image data set comprising solely data used for representation of the image content and does not directly identify the content of the image. Consequently, for example, selection by a user of the image (5) of the number four (“4”) does not reveal to spyware that the selection was a selection of the number four (“4”). This applies to each of the images in the collection of images (4) and enables the use of a numerical pass code or the like, to be hidden. More generally, the images employed within the collection of images need not be images of numbers for selection as part of a numerical input process. An image within the collection of images may be any image known to the user and carrying in the mind of the user a pre-formed association with a pre-selected internet web-page or resource as is discussed in more detail below with respect to FIGS. 4 and 5. For example, rather than employ an image (5) of the number four “4” within the collection of images, an image of a member of the user's family may be employed as supplied by the user. This image may be associated with a command to access a web-page belonging to the family member as per operation (A) above. Alternatively, the image may be associated with any other command or operation pre-specified by the user, such as a command requesting access to the personal internet banking website of the user or the initiation of an interface therefore via which access to the website may be gained following successful completion of other security requirements such as user verification.

These provisions remove the “traditional” pass-code or URL address entry methods currently employed in accessing Internet pages and resources, in favour of a choice of analogue components (e.g. the collection (4) of images of numbers “4”, “5”, “6”, “7” and “8”) which do not reveal the content of the pass-code or require the user to input a URL/address otherwise detectable via spyware.

It is to be noted that the examples of the invention described herein refer to image data sets representing image content for perception (e.g. presentation) and selection by a user. However, the user-perceptible content may be or include any one or more of: an image; sounds; video segments or any other form of user-perceptible information supporting digital manipulation.

In the case of an image, a human eye can recognise a particular image even if reasonable amounts of digital manipulation have occurred. The effects of this manipulation become even less noticeable when displaying a manipulated image that is subsequently reduced in size.

According to preferred embodiments of the invention, each image employed within the collection of images (4) is derived by digitally manipulating a larger (full-scale) master image for subsequent display in the toolbar (3) of the internet Browser (1). The Internet Browser (1) is arranged to replace the image data set representing such a displayed image after it has been selected by a user, with another image data set which differs in digital data content from the data set it replaces but which represents the same perceptible image content. As a result, a digital data set representing an image within the image collection (4) of the toolbar (3) of the Internet Browser is never used twice in to represent a selected image. This prevents spyware from making an association or correlation between the data set representing an image and the consequences of selecting that image (e.g. the issuing of a pre-specified command). Digitally speaking, the image data “looks” different each time the same image is selected by a user.

Digital manipulation of a master image data set preferably includes steps which reduce the amount of data used to represent the image in question. The use of any one of a vast multitude of different reduction techniques allows different reduced data sets to be generated with ease. FIG. 2 shows one method of reducing the size of a master image data set simply by removing the data which represents alternate horizontal lines, strips or bands (6) of the master image thereby representing the reduced image (8) using a data representing alternate horizontal lines, strips or bands (7) that are not contiguous in the master image. FIG. 3 depicts the same master image, but this time reducing its size by removing data representing alternate vertical lines, strips or bands resulting in a reduced image (10) which perceptibly looks like the reduced image (8) generated differently—though the digital data sets representing the two reduced images differ considerably.

Additional and/or alternative processes of data reduction may be applied in this way to generate different reduced image data sets for use, from a common master image. Examples include manipulating the digital image data to: increase or reduce the colour-depth of the image; increase or reduce the contrast or brightness of an image; remove or insert random data values at selected or random pixel locations within an image; amend the Fourier spectrum of the image (or audio) data; change the colour components, such as from RGB, CYMK, HSB standard to another colour representation or standard as would be readily apparent to the skilled person; remove or add un-noticeable edges from the image; apply a different compression ratio when generating an image from its master image; produce artefacts (e.g. a watermark) on the full-scale image that remain imperceptible to the human eye when viewing the reduced-scale image.

Where audio data sets are employed with or in place of image data sets, the same principles apply, namely, source audio is preferably modified prior to use/replay in such a manner as to fundamentally change the digital representation of the analogue information without perceptibly changing the same to the human listener. The audio sequence in question is preferably a sequence recognisable, most preferably of personal significance, to the user/listener—e.g. the sound of the user's voice, or a clip of the user's favourite piece of music.

The present invention, in preferred embodiments, implements the concept that each and every time a user's system presents to a user a choice of network resources or services, each option is presented via a unique, selectable and user-perceptible icon or representation that is generated by making imperceptible changes to, and subsequent reduction from, a “master” (larger vision) form of digitized analogue data.

Further, the data representing such a service can also form the basis for the generation of a one-time key to encrypt other data associated with that service, thus providing immunity from man-in-the-middle or conventional phishing attacks. In addition, by randomising the order in which such user-perceptible icons/representations are presented or appear, this invention may prevent key-logging software/spyware from gathering usable data.

The principle of using imperceptibly modified (and reduced) images may also be applied to identify or authenticate a user of a service replacing the conventional user-name and pass-code entry mechanisms used presently.

FIGS. 4 and 5 show an example of such a mechanism in operation.

In operation, a user selects from within an Internet Browser (11) or other graphical user interface, an icon (not shown) to open the service-selector toolbar (12), then selects a service from a range of available services by touching an image (13, 14, 15, 16, 17, 18) associated with that service. The images associated with a service are derived from a respective master image by imperceptibly modifying and reduced the master image using the above methods. Once the user has selected a service (image 15), a second selection interface (19) appears in the form of a regular array of other similarly modified and reduced images (twelve images; images 20 to 31) in the form of a key-pad as illustrated schematically in FIG. 5. The user then selects a sequence of the images known only to the user, by touching relevant of the images in appropriate order, and data derived from this selection sequence is transmitted to the network node providing the service associated with the service-selector toolbar image (15) previously selected to authenticate the user to that network node. The data used to represent the images of the second selection interface (19) which have been selected by the user in the above authentication process, may be used by the network node associated with the desired service in order to generate an encryption key for communications between itself and the user's system or other network node. Preferably, the method and apparatus of the user's system is arranged such that unselected of the images presented in the second selection interface (19) (i.e. images other than those presented to for use in accessing the service associated with the interface and in authenticating the service user) are images randomly selected and not relevant or known to the user. The method and apparatus of the user's system preferably is arranged such that those images (and their relative position of presentation in the second selection interface) are changed each and every time the second selection interface (19) appears for use.

Preferably, the user's system is arranged such that if a user seeking access to the network service associated with the second selection interface (19) selects one or more incorrect images (or the correct images but in a sequence which is incorrect) therefrom when attempting authentication to the service provider, the user's apparatus is directed to another network node or service other than the one intended, and selected (preferably randomly) from amongst a plurality of preselected such network services (possibly advertising services, web pages). The result is that the selection and authentication process never generates an error message even when an error is made by the user. The user device will simply be sent to an unintended web page or service without there being an objective indication (other than implicitly to the user) that the unintended web page is unintended or that an error has occurred in the user's authentication input process. This significantly improves the security of this method by rendering “brute force” attacks largely ineffective.

The invention, in preferred embodiments, also implements a method exploiting the human brain's ability to recognise a known image, sound or other information regardless of the manner chosen to digitize, store and transmit it. In the case of an image, a human will generally recognise an image of someone they know regardless of the size of the image. People will rarely notice subtle variations applied to an image, yet the underlying data representing such a modified image would vary dramatically from the original.

By changing the image (e.g. image 15, or 20 to 31) each time the user's system presents it and associating an image with a network node or service within the user's system, the user is not required to input the actual service access request directly and such service requests (typically URLs) never appear on the public network. Furthermore, by changing the data representation of the image, attempts to re-use that image data would fail, rendering the network data “replay attacks” useless.

To aid clarity, the remainder of this document may refer to images, but the invention may also utilise data representing other forms of user-perceptible content including, amongst other things, audio, video and the like.

Methods of imperceptibly modifying digitized perceptible content vary considerably. The information presented to users to allow them to select a service (or authenticate themselves to a service) can vary each time. However, this modified information still makes sense to a human user despite the underlying data having a radically different representation each time it appears.

The user's apparatus may be arranged to associate multiple images/sounds (e.g. images 15 and other images within toolbar 12) with the same network node or service. This allows a user to register several images and associate them all with a specific node or service. The master image associated with one of these images may be selected at random and then modified prior it being to sent to the user's apparatus for presentation as described above. This would further mask any image/service relationship.

The user's apparatus may be arranged to associate multiple services with a single image. This allows users to authenticate themselves to several network nodes/services/systems concurrently as described above or, to select one of a group of services associated with a common service image (15) within the service-selection toolbar, by selecting from the second selection interface (19) the image(s), or sequence thereof, associated only with the desired service. The second selection interface (19) is arranged to be responsive to a plurality of different image selections (or sequences) to authenticate the user in respect of a respective one of the multiple different services. Thus, the appropriate choice is one of several acceptable image selections/sequences as authentication to the appropriate on of several different services, acts as as an additional selection mechanism. Multiple “group” services may be registered to an image (15) within the service selection toolbar (12) and one of several different authentication combinations then permit access a respective one of several services within the service group.

The method of the invention supports multiple user-perceptible content forms/representations. For users living with disabilities or working in environments where keyboards or touch based entry systems are not possible, the invention provides methods to allow secured access to systems by using auditory data entry mechanisms. This method, therefore, can provide a secured access in any environmental conditions. For example, in place of images such as illustrated in FIGS. 4 and 5, a sight-impaired user, or a user unable to input a selection manually, maybe presented with a sequence of different audio clips, preferably in a random sequence of presentation. The apparatus of the user may be arranged to follow the presentation of each audio clip with a user selection input period of time within which the user may voice his/her selection of the presented audio clip either by stating “yes” to a microphone of the apparatus, or by stating some other affirmative statement to which voice recognition software within the user's apparatus is arranged to respond by interpreting the user's audio input as a selection of the audio clip. The apparatus may be arranged to present a subsequent audio clip to the user following expiry of the user selection input period, whether or not a selection of the previous audio clip has been entered. In this way, a user may listen to each one of a sequence of audio clips and may select only those the user recognises as being those requiring selection to access a network service. This applies to implementation of each or either of the service selection toolbar (12) and the second selection interface (19).

The method supports multiple data representations. A user may choose to select a service based on an image and authenticate to that service using sound-clips, for example.

The following describes an embodiment of the invention in more detail as a method employed to secure network communications. Examples used in the text, utilise specific technology to clarify a particular point, but do not intend to limit the invention to that specific implementation.

### Initial User Registration

In the first instance, a user of a first network apparatus (the user's apparatus) provides to a second network apparatus (the service provider) one or more data sets each representing an image (or other digitized data sets, e.g. audio and/or video) for storage at the second network apparatus e.g. within a central repository therein. The user registers one or more full-sized images (e.g. in uncompressed form) at the second network apparatus and in so doing makes an association between each such image and a particular service(s) or its(their) authentication mechanism. The user may also download from the second network apparatus a software component (e.g. user interface 11 etc) on to the first network apparatus adapted and arranged to display images and/or manage services and image associations so made as between the registered images and the registering service (second network apparatus).

### Service Registration

Services (second network apparatus) utilising the invention may provide an authentication service for users (via a first network apparatus) such that users can use a combination of images to authenticate themselves with a specific service (as per FIG. 5).

Users are required to upload data sets containing the required user-acceptable content (e.g. images/sounds). A service provider may provide a default one-time use data set or sets for use by a user temporarily until the user has uploaded their own data sets. The service provider may require that the user provides such data sets as soon as possible while, in the meantime, the default data sets provided by the service provider may be used at the user's network apparatus (e.g. images showing simple geometrical shapes with an indication to the user of which of those images should be selected (and in which order) to gain network access). Once the user has uploaded their own data sets these would then be retained either by the second network apparatus or by a separate server (a third network apparatus as described above) together with the appropriate association between the user and the user's data sets.

### Image Processing Method

For clarity, this section refers to images but the principle can apply to any digitized data capable of representing user-perceptible content.

### Data Standardisation and Cleansing

FIG. 6 depicts steps in an image processing method preferably employed in embodiments of the invention. A users apparatus uploads to the apparatus of a network service provider a large master image (32) for storage (33) at the service provider and subsequent use. At some later point (43) the apparatus of the service provider by a suitable process converts the uploaded master image into a common format chosen to be used in respect of all reduced images to be employed by the user's apparatus in subsequent service selection and authentication. The common format conversion process is arranged to removing any superfluous, spurious or undesired data or tags that would have supported image tracking or delivery of viral payloads. Preferably, the converted master image(s) are data sets purely comprised of image data (e.g. bit-maps, RAW data etc).

### Conversion to Unique Instance

In a subsequent process (35) the apparatus of the service provider then applies one or more modification filters to the data sets representing the common-format master image(s) created in step (34). This filter may involve single or multiple processes, optionally chosen at random from amongst a plurality of available processes, and may include such operations as:
reduction of colour depth (e.g. taking a 32 bit image representation to 24 bit representation);
removal of alternate lines, bands or strips of pixels in the horizontal or vertical image direction within the image frame (see FIGS. 2 and 3);
reduction or increase in contrast, saturation, brightness or intensity in the image or a part of it;
some or other process that modifies the image in a subtle manner in order that a human observer would fail to notice the modifications made when looking at the image. This may be implemented by a process of trial-and-error whereby various modification techniques and degrees of modification are tried and presented to a user who may select those which are acceptable and reject those which are not (e.g. introducing too much distortion/artefact in the modified content).

Following modification, in a subsequent process (36) the apparatus of the service provider is arranged to scale the modified image to a predetermined (typically reduced) size consistent with other unrelated images stored by the apparatus of the service provider for providing to the apparatus of the user to present to the user on a user's device (e.g. images within the service selection toolbar (12) and/or within the second selection interface (19)).

Finally, the service provider's apparatus is arranged to implement a process to compresses (37) the modified, reduced/scaled master image data into a format known to network devices using standard methods (such as JPEG, GIF, PNG etc.).

This sequence of process guarantees that an image will have considerably different representations when transmitted over a network from the service provider's apparatus to the users apparatus. The apparatus of the service provider then forms an association between the final image created in step (37) and a particular service provided by the service provider.

A suitable form of data “hashing” mechanism may be employed by the apparatus of the service provider upon the data set representing the final image, or upon the data of a number of different such final images required to be selected to authenticate a user. This reduces the amount of information required to identify the selection of image at a later stage by a user at a user's device—i.e. merely a hash value will identify the selected image(s) and only that need be transmitted to the service provider from the user device during authentication, rather than the entire data set(s) representing the selected image(s). Every time a user selects at the user's apparatus, an image generated in this way in an authentication process to the service provider, the apparatus of the service provider is arranged to transmit/provide to the user's apparatus a new, unique instance of the image created from the standardised master data set created in step (34). This ensures that any device will have a unique instance of any given image each time it presents the same to a user. The user then associates this image (or a hash value computed from the image in its new form) with a network resource.

Users may choose to upload to the service provider multiple images to associate with one service. This provides more variation to the data transmitted over the network and potentially, an additional range of data to use as a data encryption key should this information form part of an encryption mechanism.

By using the image data (or a hash of it) to associate an image with a service, a user never needs to remember an internet uniform resource locator (URL) other than for the initial registration and association process. Furthermore, by using the image data in combination with a known sequence (or a sum of a random sequence) of images, this mechanism provides a way of navigating the internet securely (as the image data forms the basis of a key used to encrypt any given requests) and authenticating the user of a particular service (only the user would know the correct combination and sequence of images to use to access a service and log-in). This also removes web-site impersonation methods as only a valid service could deploy images relevant to any given user.

A service user may also choose to use a sequence of known images to access multiple systems, thus providing mechanisms to allow federated identity management. This could allow users to access different computer systems concurrently—for example a police officer may need to access driver databases, intelligence databases and other sources of information and this invention removes the need to log into those independent services one at a time.

Images used to authenticate users may employ any one or more of several mechanisms to provide an encryption key with which the user can encrypt all transmissions. As images (e.g. image 15, or 20 to 31) change (are replaced) after each use, this would provide a reasonable level of security when a service initially makes contact.

Image hash values may be used in parallel or in series. A parallel sequence of images selected from the second selection interface (19)—selecting images 21, 23 and 29, for example—would result in the same hash value as selecting another sequence of the same images (using images 23, 21 and 29, for example). A serial hash would always have to apply in the same sequence as the generation of the hash value would be determined by a combination of the image hash values and the order in which they appear. To clarify this, consider the following hash values:
Image 21—hash value=10
Image 23—hash value=20
Image 29—hash value=30

A parallel hash value could use addition to compute a key value such as in 10+20+30=60. Any sequence using these three images (in any order) would always result in a value of 60.

A serial combination could use a different algorithm such as adding the first two values and multiplying by the third. For example, selecting images 21, 23 and 29 in that order would result in a hash value of 900, whereas selecting images 23, 29 and then 21 in that order would result in a hash value of 500. Of course, a more complex algorithm may be employed, but the above serves to illustrate the concept.

FIG. 7, and the following sequence of events, demonstrates a typical implementation and use of the invention in an Internet context.
USER: Uploads (40) to the apparatus of the network service a collection of images and associates them with services and/or authentication of services (39).
SERVICE: Processes the images in accordance with the method described with reference to FIG. 6, to produce modified images, and stores the result (41).
SERVICE: Retrieves (42) a collection of images including one or more of the modified images and a number of randomly selected (un-associated) images in sufficient quantity to fill the second selection interface (19) of the user device (43). Generates hash values for the modified images.
USER DEVICE: Stores (45) the collection of images (44) for later presentation to the user. Note that the images presented to the user at the user device will comprise relevant user-perceptible content via the modified images, padded-out with one or more of the randomly-selected (un-associated) images not known to the user.
USER: User wishes to access a network service (46). User selects (47) the relevant service icon/image from the service selection toolbar (12) presented to the user by the user device and/or selects the correct icon(s)/image(s) and/or icon/image authentication sequence at the second selection interface (19).
USER DEVICE: Calculates (48) a hash value of the image data selected by the user and transmits (49) the hash value(s) (optionally along with any data encrypted using the hash value or values, or the image data itself) to the service associated with the images chosen.
SERVICE: Evaluates (50) the image hash value(s) (e.g. by comparing the received hash value(s) to hash values held by the service in association with the relevant modified image(s) previously transmitted (44) thereby to the user's device for use in network access/authentication) and retrieves the appropriate data associated with the requested service or web-page if the received hash value(s) correspond with the corresponding hash value(s) held by the service. Optionally, decode the additional encrypted data transmitted by the user's device using a key based on the modified image or hash data held by the service. Optionally, authenticate the user based on any such additional data entered by the user. Connect to the remote service and establish a secure connection between it and the authenticated user's device. Transmit to the user's device a randomly selected web-page if authentication failed. Generate (35, 36, 37) and transmit (51) a replacement image collection for next-time use (as per step (44)).
USER DEVICE: Decodes (52) the response (51) from the service (optionally, if encrypted, decrypting it using the image data as the basis of an initial key) and presents it to the user (53). Replaces (and stores) the current image collection for this service with these new images provided from the service for next-time use of the service selection toolbar (12) and/or the second selection interface (19).
USER: Access to the service and use of the service (54).

To enhance performance, the apparatus of the service may be arranged to transmit multiple collections of new/replacement modified, reduced images to the user's device for storage thereupon e.g. in a cache for use by the user's device in replacing a used image collection immediately after use. This provides for networks where a system can download images over a slow link, yet still provide a reasonable level of performance from a user-perspective.

The extent to which a data set may be reduced or modified from a master data set yet still provide recognisable and acceptable results may be determined by a process of testing/calibration with a user whereby successive degrees of reduction/modification of a data set are provided in successive test data sets from which a user can select the appropriate level of reduction/modification extent.

Data sets conveying audio content may be implemented by initially playing the audio file at the user's apparatus, listening to the content, then dictating a response (e.g. “yes”) or performing some other manual input operation at the user's device, in order to select the appropriate audio data. During the process of registration a user may upload a plurality (perhaps a large number) of separate data sets of user-perceptible content each of which will be usable, when in reduced form, for subsequently requesting access to those services for which registration is being performed. The plurality of data sets may be grouped into a number of different groups if it is intended to require selection of a sequence of content items by a user requesting services. For example, a first group of the uploaded images may be identified as being those data sets from which a first content item in a sequence is to be selected, a second group of data sets from which the second content item in the sequence is to be selected and so on. The user may thus determine the sequences and the possible items of content to be used in those sequences at the registration process.

As will be readily appreciated by the skilled person, a “hash” or “hash function” is a term used to identify a mathematical process or algorithm for processing numbers or data to produce a number or result unique to that data according to the hash function. In preferred embodiments of the invention, a single hash function may be applied collectively to all of the data sets selected within a given selection sequence by a user, or hash functions may be applied individually to selected data sets within a sequence and a final hash value calculated using the separate has values and optionally according to the order in which the associated data sets were elected by the user. Examples include so-called parallel or serial hash functions. Preferably the apparatus of the service (e.g. the second network component or/and the third network component) when generating hash functions and hash values data sets to be used by a user, are arranged to check that a degeneracy does not exist in the hash function or values—that is to say that a hash function should not be such that the same input data can produce two different output hash values. Similarly it is preferable that the apparatus checks that the hash functions are not such that two different input data sets produce the same output hash value. In such cases the hash function is preferably amended.

Preferably the service apparatus initially sends to the user device appropriate hash algorithms at the registration phase with which the user's apparatus may generate hash values for transmission to the service apparatus in a subsequent process of service access request. These hash functions may be transmitted to the user's apparatus together with the user-perceptible data sets with which they are associated and which are to be used by the user's apparatus.

Of course, if a payload is also transmitted by the user's apparatus to the service apparatus (or vice versa) then the payload may be encrypted using the hash value generated from an aforementioned data set. Alternatively, the content of the data sets representing the user-perceptible content may themselves be used to encrypt a payload using a separate algorithm known to the service apparatus for decrypting the payload.

The above embodiments are intended as non-limiting examples of the invention the scope of which is intended to encompass modifications, variants and adaptations of the examples such as would be readily apparent to the skilled person.

1. A method for securing communications in a communications network between a first network component and a second network component including:
providing at the first network component a first data set representing user-perceptible content, and reproducing the user-perceptible content using the first data set for perception and selection by a user of the first network component; and
forming a network communications link between the first network component and the second network component subject to conditions requiring at least that a user input is received at the first network component indicating selection of the reproduced user-perceptible content by the user; and subsequently,
issuing to the first network component a second data set from network communications apparatus comprising at least the second network component which differs from the first data set but which represents the same said user-perceptible content;
replacing the first data set with the second data set at the first network component to represent the user-perceptible content for perception and selection by a user of the first network component in subsequently so forming a said communications link.

2. A method according to claim 1, in which said forming of said communications link includes:
issuing a request signal from the first network component to the network communications apparatus requesting formation of the communications link wherein the request signal comprises data identifiable by the network communications apparatus as having been uniquely derived from the first data set; and
authenticating at the network communications apparatus the user of the first network component using the request signal, and subsequently issuing said second data set.

3. A method according to claim 2 including generating said request signal comprising a numerical value derived from said first data set by applying thereto a numerical algorithm applicable by the network communications apparatus to identify the numerical value as having been derived from the first data set.

4. A method according to claim 2 including generating said request signal comprising said first data set.

5. A method according to claim 1 in which said forming of said communications link includes:
generating at the first network component a user interface via which access to the second network component is obtainable by forming said communications link; and wherein
said issuing to the first network component of the second data set from the network communications apparatus is subject to the condition that said access is obtained using the user interface.

6. A method according to claim 1 including generating the first data set and the second data set using a common master data set which represents the user-perceptible content.

7. A method according to claim 6 including generating the second data set at the network communications apparatus for the first network component.

8. A method according to claim 6 including generating the first data set and the second data set to comprise less data than is employed by the master data set to represent the user-perceptible content.

9. A method according to claim 8 including generating the first data set and the second data set comprising data which is sub-sampled from the master data set.

10. A method according to claim 8 in which the master data set represents an image, the method including generating the first data set and the second data set such that said image content reproduced therefrom is relatively shrunken as compared to the image content represented by the master data set if so reproduced.

11. A method according to claim 1 including:
providing at the first network component a plurality of said first data sets which represent a respective user-perceptible content;
reproducing the user-perceptible content of the plurality of first data sets simultaneously for perception and selection by the user of the first network component;
forming said network communications link subject to conditions requiring at least that said user input is received indicating the selection of more than one of the reproduced user-perceptible content by the user.

12. A method according to claim 11 in which said conditions include a requirement that the order of selection of said more than one reproduced user-perceptible contents matches a predetermined order.

13. A method according to claim 6, including providing a plurality of distinct said master data sets and generating said first and/or second data set from a master data set selected from amongst the plurality of master data sets.

14. A method according to claim 1 including:
issuing to the first network component from the network communications apparatus a third data set in association with said second data set which represents a different user-perceptible content;
reproducing the user-perceptible contents of both the second data set and the third data set simultaneously for perception and selection by a user of the first network component.

15. Apparatus for securing communications in a communications network between a first network component and a second network component including;
a first network component comprising a first data set representing user-perceptible content, and arranged to reproduce the user-perceptible content using the first data set for perception and selection by a user of the first network component; and
network communications apparatus comprising at least a second network component arranged to form a network communications link between the first and second network components subject to conditions requiring at least that a user input is received at the first network component indicating selection of the reproduced user-perceptible content by the user; and subsequently to issue to the first network component a second data set which differs from the first data set but which represents the same said user-perceptible content;
wherein the first network component is arranged to replace the first data set with the second data set to represent the user-perceptible content for perception and selection by a user of the first network component in subsequently so forming a said communications link.

16. Apparatus according to claim 15 in which:
the first network component is arranged to issue a request signal to the network communications apparatus requesting formation of the communications link wherein the request signal comprises data identifiable by the network communications apparatus as having been uniquely derived from the first data set; and
the network communications apparatus is arranged to authenticate the user of the first network component using the request signal, and subsequently to issue said second data set.

17. Apparatus according to claim 16 in which the first network component is arranged to generate said request signal comprising a numerical value derived from said first data set by applying thereto a numerical algorithm applicable by the network communications apparatus to identify the numerical value as having been derived from the first data set.

18. Apparatus according to claim 16 or in which the first network component is arranged to generate the request signal comprising said first data set.

19. Apparatus according to claim 15 in which:
the first network component is arranged to generate a user interface via which access to the second network component is obtainable by forming said communications link; and wherein
the network communications apparatus is arranged to issue the second data set to the first network component subject to the condition that said access is obtained using the user interface.

20. Apparatus according to claim 15 arranged to generate the first data set and the second data set using a common master data set which represents the user-perceptible content.

21. Apparatus according to claim 20 in which the network communications apparatus is arranged to generate the second data set for the first network component.

22. Apparatus according to claim 20 arranged to generate the first data set and the second data set to comprise less data than is employed by the master data set to represent the user-perceptible content.

23. Apparatus according to claim 22 arranged to generate the first data set and the second data set comprising data which is sub-sampled from the master data set.

24. Apparatus according to claim 22 in which the master data set represents an image, the network communications apparatus being arranged to generate the first data set and the second data set such that said image content reproduced therefrom is relatively shrunken as compared to the image content represented by the master data set if so reproduced.

25. Apparatus according to claim 15 in which:
the first network component contains a plurality of said first data sets which represent a respective user-perceptible content, wherein;
the first network component is arranged to reproduce the user-perceptible content of the plurality of first data sets simultaneously for perception and selection by the user of the first network component;
the network communications apparatus is arranged to form said network communications link subject to conditions requiring at least that said user input is received indicating the selection of more than one of the reproduced user-perceptible content by the user.

26. Apparatus according to claim 25 in which said conditions include a requirement that the order of selection of said more than one reproduced user-perceptible contents matches a predetermined order.

27. Apparatus according to claim 20, comprising a plurality of distinct said master data sets and arranged to generate said first and/or second data set from a master data set selected from amongst the plurality of master data sets.

28. Apparatus according to claim 15 in which:
the network communications apparatus is arranged to issue to the first network component a third data set in association with said second data set which represents a different user-perceptible content;
the first network component is arranged to reproduce the user-perceptible contents of both the second data set and the third data set simultaneously for perception and selection by a user of the first network component.

29. Apparatus for securing communications in a communications network between a first network component and a second network component including:
said second network component comprising a master data set representing user-perceptible content, and arranged to generate a first data set derived from and differing from said master data set representing the user-perceptible content for reproduction, perception and selection by a user of the first network component; wherein,
the second network component is arranged to transmit said first data set to said first network component and subsequently to form a network communications link with the first network component subject to conditions requiring at least that data is received thereby from the first network component indicating selection of the reproduced user-perceptible content by the user; and subsequently to issue to the first network component a second data set derived from the master data set which differs from the first data set but which represents the same said user-perceptible content for subsequent perception and selection by a user of the first network component in subsequently so forming a said communications link.

30. A method for securing communications in a communications network between a first network component and a second network component including:
providing at the second network component a master data set representing user-perceptible content, and generating therefrom a first data set differing from said master data set representing the user-perceptible content for reproduction, perception and selection by a user of the first network component; and
transmitting said first data set to said first network component and subsequently forming a network communications link with the first network component subject to conditions requiring at least that data is received by the second network component from the first network component indicating selection of the reproduced user-perceptible content by the user; and subsequently,
issuing to the first network component a second data set derived from the master data set which differs from the first data set but which represents the same said user-perceptible content for perception and selection by a user of the first network component for use in subsequently so forming a said communications link.

31. A computer program comprising computer-executable instructions executable by a computer to implement the method of claim 1.

32. A computer program product comprising a computer-readable data storage medium comprising computer-executable instructions executable by a computer to implement the method of claim 1.

33. A computer containing the computer program according to claim 31 programmed to implement the method for securing communications in a communications network between a first network component and a second network component including:
providing at the first network component a first data set representing user-perceptible content, and reproducing the user-perceptible content using the first data set for perception and selection by a user of the first network component; and
forming a network communications link between the first network component and the second network component subject to conditions requiring at least that a user input is received at the first network component indicating selection of the reproduced user-perceptible content by the user; and subsequently,
issuing to the first network corn anent a second data set from network communications apparatus comprising at least the second network component which differs from the first data set but which represents the same said user-perceptible content;
replacing the first data set with the second data set at the first network component to represent the user-perceptible content for perception and selection by a user of the first network component in subsequently so forming a said communications link.

34. A communications network comprising the apparatus according to claim 15.

35. Apparatus according to claim 15 arranged to implement the method for securing communications in a communications network between a first network component and a second network component including:
providing at the first network component a first data set representing user-perceptible content, and reproducing the user-perceptible content using the first data set for perception and selection by a user of the first network component; and
forming a network communications link between the first network component and the second network component subject to conditions requiring at least that a user input is received at the first network component indicating selection of the reproduced user-perceptible content by the user; and subsequently,
issuing to the first network component a second data set from network communications apparatus comprising at least the second network component which differs from the first data set but which represents the same said user-perceptible content;
replacing the first data set with the second data set at the first network component to represent the user-perceptible content for perception and selection by a user of the first network component in subsequently so forming a said communications link.

36-37. (canceled)
